(19) United States
(12) Patent Application Publication
(10) Pub. No.: US 2025/0157189 A1
(43) Pub. Date: May 15, 2025

(54) IMAGE PROCESSING APPARATUS

(71) Applicant: CANON KABUSHIKI KAISHA, Tokyo (JP)

(72) Inventors: YASUNARI NAGAMATSU, Kanagawa (JP); SHIGEO KODAMA, Tokyo (JP)

(21) Appl. No.: 18/939,327

(22) Filed: Nov. 6, 2024

(30) Foreign Application Priority Data
Nov. 10, 2023 (JP) 2023-192291

(51) Int. Cl. G06V 10/74; G06V 10/75

(52) U.S. Cl. CPC G06V 10/761; G06V 10/751

(57) ABSTRACT

An apparatus includes a first calculation unit configured to calculate a total sum of a correlation value between a first matching region of a baseline image and a first matching region of a reference image in a horizontal direction for each row and store, in a holding unit, a value for each row based on the total sum of the correlation value in the horizontal direction for each row, and a second calculation unit configured to calculate a total sum of a correlation value between the first matching region of the baseline image and the first matching region of the reference image in a vertical direction, based on the total sum of the correlation value between the first matching region of the baseline image and the first matching region of the reference image in the horizontal direction for each row.

### BACKGROUND

### Technical Field

The aspect of the embodiments relates to an image processing apparatus and a processing method of the image processing apparatus.

### Description of the Related Art

Among technologies for a digital camera installed as an information acquisition sensor for automated driving and an industrial robot is detection of a distance to a subject using a phase difference method with pixels (hereinafter, also referred to as “distance measurement pixels”) having a distance measurement function incorporated as some or all of pixels of an image sensor.

In this method, a plurality of photoelectric conversion portions is disposed in the distance measurement pixels and configured to guide light beams having passed through different regions on a pupil of an imaging lens to different photoelectric conversion portions. Optical images (hereinafter, referred to as “image A” and “image B”) formed by the light beams having passed through different pupil regions are acquired based on signals output by the photoelectric conversion portions included in the distance measurement pixels, and a plurality of images is acquired based on the images A and B. The pupil region corresponding to the image A and the pupil region corresponding to the image B are decentered in different directions from each other along an axis referred to as a pupil division direction.

A relative position displacement corresponding to a defocus amount occurs between the plurality of acquired images (hereinafter, referred to as “image A” and “image B”) in the pupil division direction. This position displacement is referred to as an image displacement, and an amount of image displacement is referred to as an image displacement amount. By converting the image displacement amount (parallax) to a defocus amount via a predetermined conversion coefficient, a distance to a subject is calculated. With the foregoing method, unlike contrast methods, the lens does not have to be moved to measure the distance, which leads to the distance measurement at high speed with high accuracy.

To calculate parallax, a region-based corresponding point search technology referred to as template matching is generally used. In template matching, one of the images A and B is used as a baseline image, and the other is used as a reference image. A local region (hereinafter, “matching region” or “block”) centered at a focus point is set on the baseline image, and a matching region centered at a reference point corresponding to the focus point is also set on the reference image. Then, a search for a point with the highest correlation (i.e., similarity) between the images A and B in the matching region is performed while sequentially changing the reference point.

The parallax calculation is performed based on the amount of displacement between relative positions of the point and the focus point.

Various technologies related to template matching are developed, and Japanese Patent Application Laid-Open No. 2018-26032 discusses a technology that realizes a reduction in the number of operations and the number of arithmetic units, and at the same time, an increase in processing speed.

In the template matching described above, the number of operations is reduced by reusing results of area correlation operations in a column direction, compared to cases without reusing. However, the template matching has an issue that in a case where a matching region is enlarged, operation costs increase with the size of the matching region.

### SUMMARY

According to an aspect of the embodiments, an apparatus includes a first calculation unit configured to calculate a total sum of a correlation value between a first matching region of a baseline image and a first matching region of a reference image in a horizontal direction for each row and store, in a holding unit, a value for each row based on the total sum of the correlation value in the horizontal direction for each row, and a second calculation unit configured to calculate a total sum of a correlation value between the first matching region of the baseline image and the first matching region of the reference image in a vertical direction, based on the total sum of the correlation value between the first matching region of the baseline image and the first matching region of the reference image in the horizontal direction for each row, wherein the first calculation unit calculates a total sum of a correlation value between a second matching region of the baseline image and a second matching region of the reference image in the horizontal direction for each row using the value for each row that is stored in the holding unit, wherein the second calculation unit calculates a total sum of a correlation value between the second matching region of the baseline image and the second matching region of the reference image in the vertical direction, based on the total sum of the correlation value between the second matching region of the baseline image and the second matching region of the reference image in the horizontal direction for each row, wherein the first matching region and the second matching region of the baseline image partially overlap with each other, and wherein the first matching region and the second matching region of the reference image partially overlap with each other.

Further features of the disclosure will become apparent from the following description of exemplary embodiments with reference to the attached drawings.

### BRIEF DESCRIPTION OF THE DRAWINGS

FIG. 1 is a diagram illustrating an example of a configuration of an image processing apparatus.

FIG. 2 is a diagram illustrating an example of a configuration of a correlation value calculation unit.

FIG. 3 is a diagram illustrating an example of a template matching process.

FIG. 4 is a diagram illustrating an example of a process of calculating total sums of correlation values in a horizontal direction.

FIG. 5 is a diagram illustrating an example of a process of calculating total sums of correlation values in a vertical direction.

FIG. 6 is a diagram illustrating a comparison of the number of correlation value calculation operations per pixel.

FIGS. 7A and 7B are diagrams illustrating the number of operations for each block size and search area.

FIG. 8 is a flowchart illustrating a process of the correlation value calculation unit.

FIG. 9 is a diagram illustrating an example of a process of calculating total sums of correlation values in the horizontal direction.

FIG. 10 is a diagram illustrating a comparison of the number of correlation value calculation operations per pixel.

FIG. 11 is a diagram illustrating an example of a process of calculating total sums of correlation values in the horizontal direction.

FIG. 12 is a diagram illustrating a comparison of the number of correlation value calculation operations per pixel.

### DESCRIPTION OF THE EMBODIMENTS

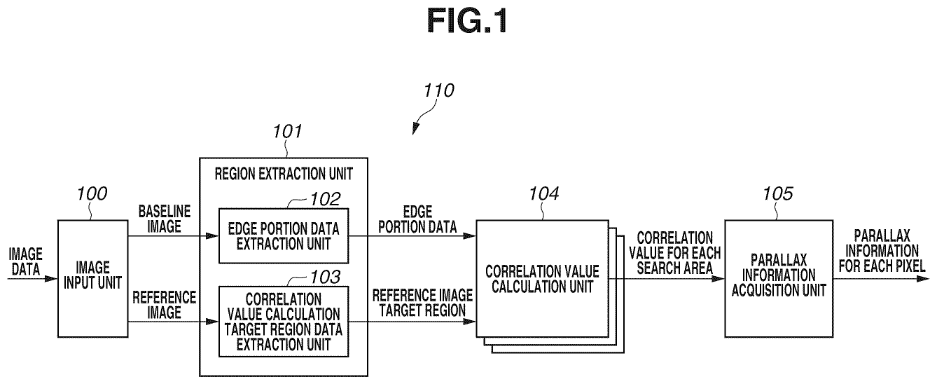

FIG. 1 is a diagram illustrating an example of a configuration of an image processing apparatus 110 according to a first exemplary embodiment. The image processing apparatus 110 includes an image input unit 100, a region extraction unit 101, a plurality of correlation value calculation units 104, and a parallax information acquisition unit 105. The region extraction unit 101 includes an edge portion data extraction unit 102 and a correlation value calculation target region data extraction unit 103.

The image input unit 100 receives a plurality of pieces of image data captured by a stereo camera or the like and transmits a baseline image and a reference image to the region extraction unit 101. The baseline image is one of the plurality of pieces of image data, and the reference image is another one of the plurality of pieces of image data.

The region extraction unit 101 transmits the baseline image to the edge portion data extraction unit 102 and transmits the reference image to the correlation value calculation target region data extraction unit 103.

The edge portion data extraction unit 102 extracts left edge data and right edge data (edge portion data) of the same line as a target pixel at the center of a matching region (hereinafter, also referred to as “block”) from the baseline image and transmits the edge portion data to the correlation value calculation units 104.

In order to calculate a correlation with the baseline image extracted by the edge portion data extraction unit 102, the correlation value calculation target region data extraction unit 103 extracts target region data from the reference image by factoring in a search area and a block size of the corresponding target pixel. Specifically, the correlation value calculation target region data extraction unit 103 extracts target region data of “search area+horizontal block size×2−1” and transmits the extracted data to the correlation value calculation units 104. Since the image data captured by the stereo camera is used, a search direction of the reference image is the horizontal direction.

The plurality of correlation value calculation units 104 calculates, for each search position in the search area, a correlation value between the baseline image and the reference image using the edge portion data of the baseline image that is extracted by the edge portion data extraction unit 102 and the target region data of the reference image. A publicly-known method is usable to calculate the correlation values. For example, a method referred to as the Sum of Absolute Difference (SAD) can be used to calculate total sums of absolute values of differences between pixel values as evaluation values. While the SAD is used in the present exemplary embodiment, the SAD is not a limiting method, and a different method such as the Sum of Squared Difference (SSD) may be used. Details of a configuration of the correlation value calculation units 104 will be described below.

The parallax information acquisition unit 105 receives the correlation values calculated for each search position by the correlation value calculation units 104 and outputs an image displacement amount of the search position with the smallest evaluation value as parallax information.

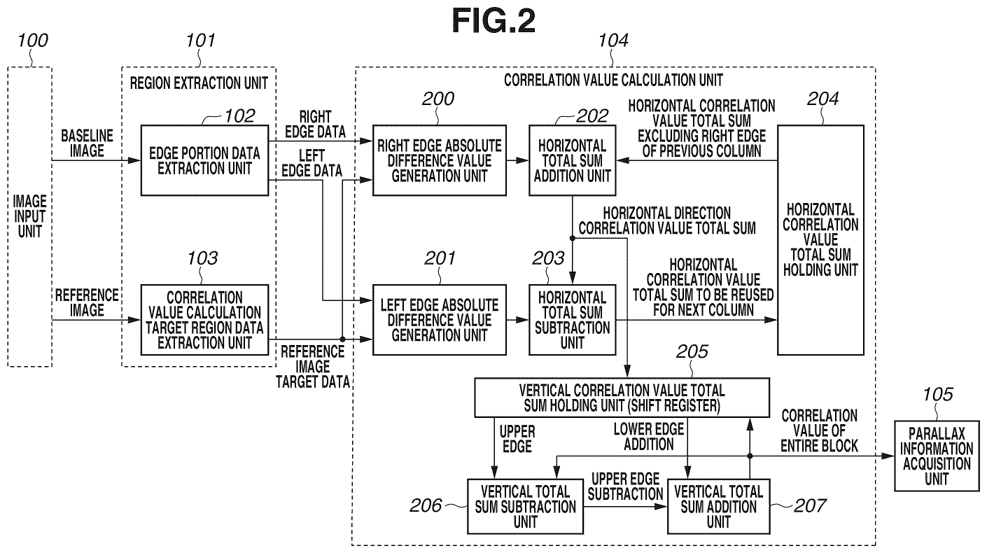

FIG. 2 is a diagram illustrating an example of a configuration of the correlation value calculation units 104 in FIG. 1. Each correlation value calculation unit 104 includes a right edge absolute difference value generation unit 200, a left edge absolute difference value generation unit 201, a horizontal total sum addition unit 202, a horizontal total sum subtraction unit 203, and a horizontal correlation value total sum holding unit 204. Each correlation value calculation unit 104 further includes a vertical correlation value total sum holding unit 205, a vertical total sum subtraction unit 206, and a vertical total sum addition unit 207.

The right edge absolute difference value generation unit 200 generates an absolute difference value between the right edge data of the block size centered at the target pixel in the baseline image that is extracted by the edge portion data extraction unit 102 and the corresponding right edge data of the reference image for each search position that is extracted by the correlation value calculation target region data extraction unit 103.

The left edge absolute difference value generation unit 201 generates an absolute difference value between the left edge data of the block centered at the target pixel in the baseline image that is extracted by the edge portion data extraction unit 102 and the corresponding left edge data of the reference image for each search position that is extracted by the correlation value calculation target region data extraction unit 103.

The horizontal total sum addition unit 202 reads a total sum of horizontal correlation values excluding the absolute difference value of the right edge from the horizontal correlation value total sum holding unit 204, adds the absolute difference value of the right edge data that is generated by the right edge absolute difference value generation unit 200 to the read total sum of horizontal correlation values, and calculates a total sum of correlation values in the horizontal direction. The calculated total sum of correlation values in the horizontal direction is transmitted to the horizontal total sum subtraction unit 203 and the vertical correlation value total sum holding unit 205.

The horizontal total sum subtraction unit 203 calculates an intermediate value of the total sum of correlation values in the horizontal direction that is to be reused for the next column, by subtracting the absolute difference value of the left edge data that is generated by the left edge absolute difference value generation unit 201 from the total sum of horizontal correlation values that is generated by the horizontal total sum addition unit 202. Then, the horizontal total sum subtraction unit 203 transmits the intermediate value of the total sum of correlation values in the horizontal direction to the horizontal correlation value total sum holding unit 204.

The horizontal correlation value total sum holding unit 204 holds the intermediate value of the total sum of correlation values in the horizontal direction that is obtained by excluding the absolute difference value of the right edge of the block from the total sum of absolute difference values in the horizontal direction. The horizontal correlation value total sum holding unit 204 transmits the intermediate value to the horizontal total sum addition unit 202 and receives the intermediate value from the horizontal total sum subtraction unit 203.

The vertical correlation value total sum holding unit 205 stores the total sum of correlation values in the horizontal direction that is generated by the horizontal total sum addition unit 202 in a shift register.

The vertical total sum subtraction unit 206 subtracts the total sum of correlation values in the horizontal direction of the frontmost column of the shift register in the vertical correlation value total sum holding unit 205 from a correlation value for the entire block. The correlation value for the entire block is the total sum in the vertical direction that is calculated by the vertical total sum addition unit 207 for the processing of the next pixel. The frontmost column of the shift register corresponds to upper edge pixel positions of the block centered at the target pixel.

The vertical total sum addition unit 207 calculates the correlation value for the entire block by adding the total sum of correlation values in the horizontal direction of the last column of the shift register that is held in the vertical correlation value total sum holding unit 205 to the intermediate value of the total sum of correlation values in the vertical direction that is calculated by the vertical total sum subtraction unit 206. The last column of the shift register corresponds to lower edge pixel positions of the block centered at the target pixel. The correlation value for the entire block is transmitted to the parallax information acquisition unit 105.

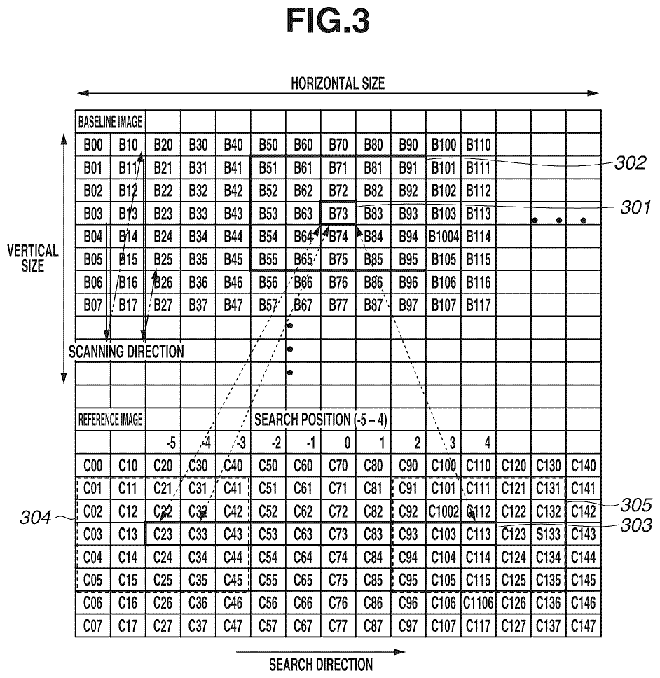

Specific processing details will be described below with reference to FIGS. 3 to 5. FIG. 3 is a diagram illustrating an example of a template matching process of the correlation value calculation units 104 according to the present exemplary embodiment.

In the present exemplary embodiment, a description will be given of an example of operations of a case where the block size is 5×5 and the search area is 10 (−5 to 4). In FIG. 3, a baseline image B and a reference image C are illustrated, and since the image data captured by the stereo camera is used, the search direction is the horizontal direction, while the images are input and scanned in a vertical direction.

Each pixel of the baseline image B and the reference image C is input one at a time from the image input unit 100. Specifically, a pixel B00 is input, and a pixel B01 is input in the next cycle. Then, after the input of one column in the vertical direction is completed, a pixel B10 of the next column is input.

In a case where a pixel B73 is determined as a target pixel 301 in the baseline image B, a 5×5 matching region 302 centered at the pixel B73 is set as a correlation operation target block in the baseline image B. In the reference image C, 5×5 matching regions centered at search positions C23 to C113 in a search area 303 are set as correlation operation target blocks.

The correlation value calculation units 104 perform a correlation operation (calculation of total sums of absolute values of differences between the pixels of the baseline image B and the pixels of the reference image C) between the 5×5 matching region 302 in the baseline image B and each 5×5 matching region in the reference image C.

A matching region 304 in the reference image C is a 5×5 matching region for a case where the search position is-5. A matching region 305 in the reference image C is a 5×5 matching region for a case where the search position is 4. The search position with the smallest result among the results of the correlation operation for each search position is determined as a parallax value.

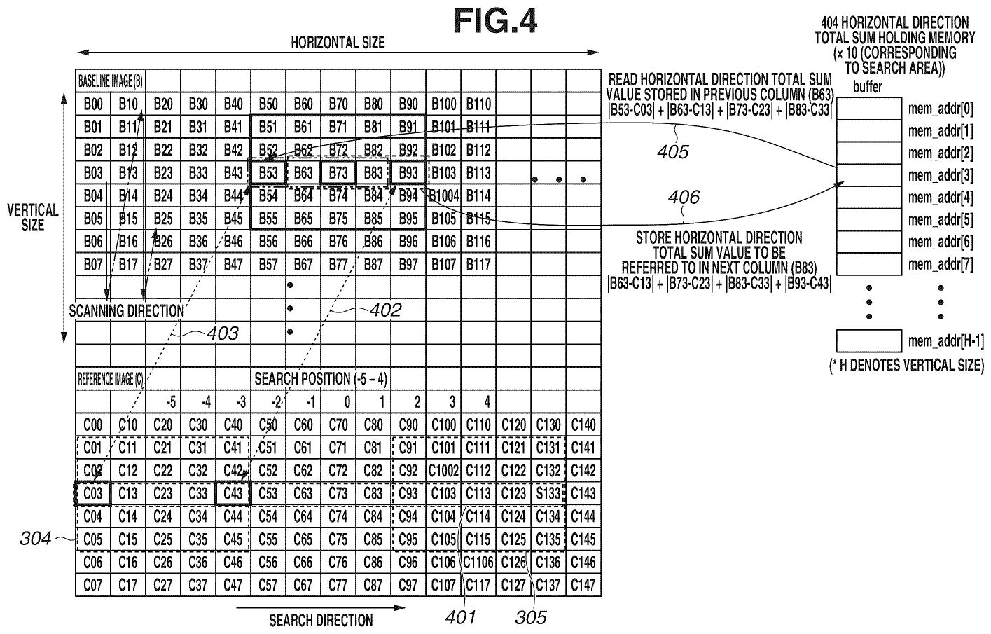

FIG. 4 is a diagram illustrating a process of calculating total sums of correlation values in the horizontal direction in the template matching operation of the correlation value calculation units 104 according to the present exemplary embodiment.

In a case where the pixel B73 is determined as a target pixel in the baseline image B, the edge portion data extraction unit 102 extracts a right edge pixel B93 and a left edge pixel B53. The correlation value calculation target region data extraction unit 103 extracts pixel data of a correlation calculation region 401 of pixels C03 to C133 from the reference image C.

Next, the right edge absolute difference value generation unit 200 performs calculation of absolute difference values between the extracted right edge pixel B93 and the pixels in the reference image C. The calculation of absolute difference values is performed for each search position, and in a case where the focus is on the matching region 304 of the search position “−5”, |B93−C43| is a right edge absolute difference value 402.

Similarly, the left edge absolute difference value generation unit 201 performs the calculation of absolute difference values between the extracted left edge pixel B53 and the pixels in the reference image C. In a case where the focus is on the matching region 304 of the search position “−5”, |B53−C03| is a left edge absolute difference value 403.

The horizontal total sum addition unit 202 reads, from a horizontal direction total sum holding memory 404 (horizontal correlation value total sum holding unit 204), a horizontal correlation value total sum intermediate value 405 (|B53−C03|+|B63−C13|+|B73−C23|+|B83−C33|) without the right edge absolute difference value (|B93−C43|) and adds the right edge absolute difference value to the read value. This addition completes the total sum of correlation values in the horizontal direction (|B53−C03|+|B63−C13|+|B73−C23|+|B83−C33|+|B93−C43|) with the pixel B73 being the target pixel, and the total sum of correlation values in the horizontal direction is transmitted to the vertical correlation value total sum holding unit 205.

The horizontal total sum subtraction unit 203 subtracts the left edge absolute difference value (|B53−C03|) from the total sum of correlation values in the horizontal direction that is calculated by the horizontal total sum addition unit 202. Then, the subtraction result, which is a next column reference horizontal correlation total sum value 406 (|B63−C13|+|B73−C23|+|B83−C33|+|B93−C43|), is stored in the corresponding location (same line position as the target pixel:mem_addr[3]) in the horizontal correlation value total sum holding unit 204.

The next column reference horizontal correlation total sum value 406, which is the result stored in the horizontal correlation value total sum holding unit 204 by the horizontal total sum subtraction unit 203, is read during the scanning of the next column (case where the target pixel is B83) and utilized to calculate a total sum of correlation values in the horizontal direction of the next column.

The horizontal correlation value total sum holding unit 204 is composed of memories with addresses sufficient for the vertical size of the input image, and the memories sufficient for the search area are used. Thus, in a case where the search area is −5 to 4, ten memories are implemented.

The process of calculating total sums of correlation values in the horizontal direction is performed in parallel for each search position in the search area.

For example, in a case where the focus is on the search position “−4”, |B93−C53| and |B53−C13| are the right edge absolute difference value and the left edge absolute difference value, respectively, and the process is performed in parallel similarly to the case where the search position is “−5”.

After completion of the process of calculating total sums of correlation values in the horizontal direction on the target pixel B73 and in a case where the next pixel B74 is determined as a target pixel, a total sum of correlation values in the horizontal direction is calculated similarly for the search area. In the case where the search position is “−5”, (|B54−C04|+|B64−C14|+|B74−C24|+|B84−C34|+|B94−C44|) is the total sum of correlation values in the horizontal direction.

Thereafter, the scanning process is continued, and the calculation of the total sum of correlation values in the horizontal direction is performed for all search positions in the search area by reusing the total sum of correlation values in the horizontal direction of the previous column. Operations for calculating the total sum of correlation values in the horizontal direction in units of pixels are the following four operations for each search area.
Subtraction of the absolute difference value of the right edge pixel (Operation a)
Subtraction of the absolute difference value of the left edge pixel (Operation b)
Addition of the total sum in the horizontal direction (Operation c)
Subtraction of the next column reference horizontal correlation total sum value (Operation d)

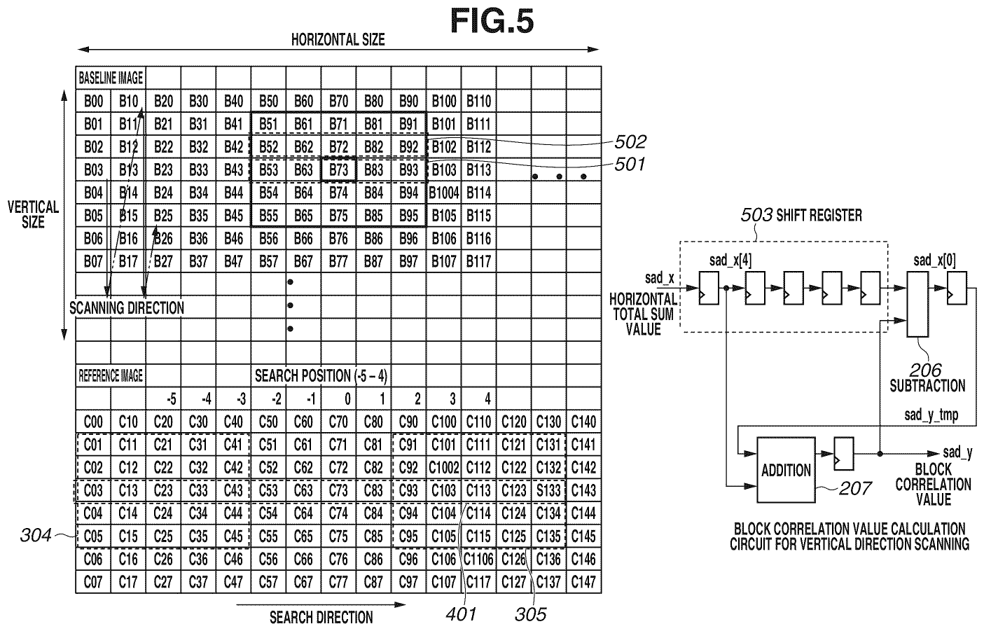

FIG. 5 is a diagram illustrating a process of calculating total sums of correlation values in the vertical direction in the template matching operation of the correlation value calculation units 104 according to the present exemplary embodiment.

In the calculation of total sums of correlation values in the vertical direction, each time the scanning is performed, a total sum of correlation values in the horizontal direction correlation is sequentially stored in a shift register 503. In a case where the pixel B73 is determined as a target pixel in the baseline image B, the horizontal total sum addition unit 202 calculates a total sum of correlation values in the horizontal direction (|B53−C03|+|B63−C13|+|B73−C23|+|B83−C33|+|B93−C43|) for a horizontal correlation value total sum calculation region 501 of the target pixel B73. This calculation result is stored in the shift register 503 of the vertical correlation value total sum holding unit 205.

In a case where the target pixel is the immediately previous pixel, i.e., pixel B72, a total sum of correlation values in the horizontal direction for a horizontal correlation value total sum calculation region 502 of the target pixel B72 that is calculated by the horizontal total sum addition unit 202 is (|B52−C02|+|B62−C12|+|B72−C22|+|B82−C32|+|B92−C42|). This total sum of correlation values in the horizontal direction is stored in the immediately previous register in the shift register 503 of the vertical correlation value total sum holding unit 205.

The right part of FIG. 5 illustrates an example of a configuration of the shift register 503 (vertical correlation value total sum holding unit 205), the vertical total sum subtraction unit 206, and the vertical total sum addition unit 207. A total sum sad_x of correlation values in the horizontal direction that is output by the horizontal total sum addition unit 202 is stored in the shift register 503, and data corresponding to the vertical block size is stored.

The vertical total sum addition unit 207 adds a horizontal total sum value sad_x[4] of the lower edge centered at the target pixel to an intermediate total sum value sad_y_tmp to calculate a total sum in the vertical direction, i.e., a correlation value sad_y for the entire block of the entire block size (5×5). The correlation value sad_y for the entire block is to be updated. Thus, the vertical total sum subtraction unit 206 subtracts a horizontal total sum value sad_x[0] of the upper edge centered at the target pixel from the correlation value sad_y for the entire block to calculate an intermediate total sum value sad_y_tmp in the vertical direction for the next pixel. Operations for calculating a total sum of correlation values in the vertical direction in units of pixels are the following two operations for each search area.
Addition of the horizontal total sum value of the lower edge of the target pixel, sad_y=sad_y_tmp+sad_x[4]] (Operation e)
Subtraction of the horizontal total sum value of the upper edge of the target pixel, sad_y_tmp=sad_y−sad_x[0]] (Operation f)

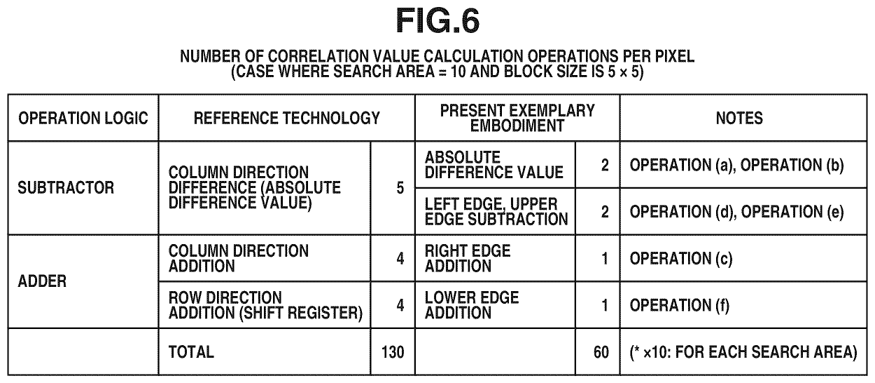

FIG. 6 is a diagram illustrating a comparison of the number of operations per pixel in the template matching operation between a reference technology and the present exemplary embodiment.

In the case of performing the calculation of correlation values on a block size of 5×5 centered at a target pixel according to the reference technology, first, total sums of absolute difference values are calculated in units of columns in the vertical direction. Since the operations are performed in units of columns, in one embodiments, five subtractors are used to calculate absolute difference values from a baseline image and a reference image, and four adders are used to calculate total sums of the absolute difference values in the vertical direction. Four adders are used to store the calculated total sums in the vertical direction in a shift register and to calculate total sums in the horizontal direction collectively in units of rows. According to the reference technology, thirteen arithmetic units are used for the correlation value calculation operation per pixel, and in a case where performing the process in parallel for each search position is considered, one hundred and thirty arithmetic units are used.

According to the present exemplary embodiment, in the case of performing the correlation value calculation on the block size of 5×5 centered at the target pixel, the operations are performed in units of not columns but pixels as illustrated in FIGS. 4 and 5. Two subtractors are used to calculate absolute difference values of the edge portion data in the horizontal direction. Four adders/subtractors are used for the addition of the absolute difference value of the right edge in the horizontal direction, the subtraction of the absolute difference value of the left edge in the horizontal direction, the addition of the total sum value in the horizontal direction of the lower edge in the vertical direction, and the subtraction of the total sum value in the horizontal direction of the upper edge in the vertical direction. According to the present exemplary embodiment, six arithmetic units are used for the correlation value calculation operation per pixel, and in a case where performing the process in parallel for each search position is considered, sixty arithmetic units are used. Therefore, the number of necessary arithmetic units according to the present exemplary embodiment is less than the number of necessary arithmetic units according to the reference technology.

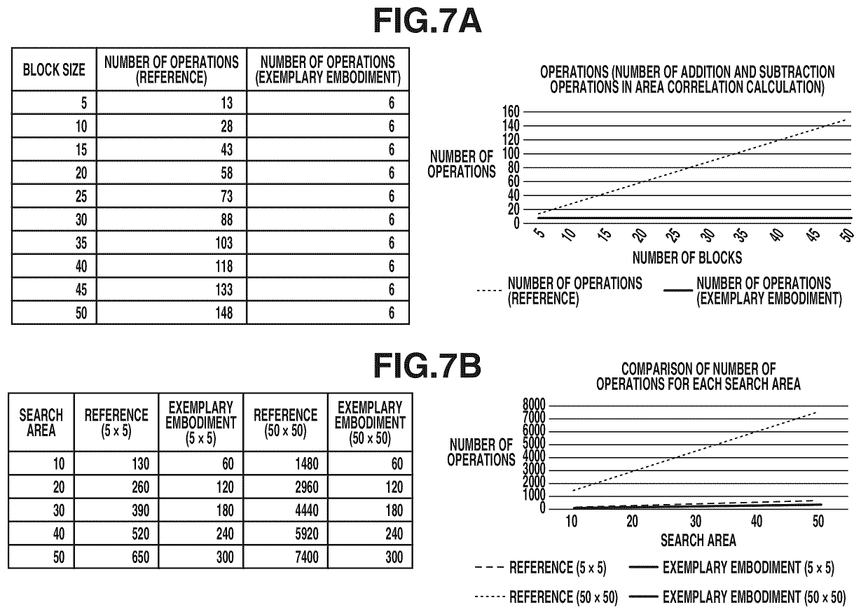

FIG. 7A is a diagram illustrating a difference in the number of operations for different block sizes in the template matching operation between the reference technology and the present exemplary embodiment. According to the reference technology, as the block size increases, the number of operations also increases. According to the present exemplary embodiment, on the other hand, the number of operations does not depend on the block size, so that even in a case where the block size is increased, the number of operations remains unchanged.

FIG. 7B is a diagram illustrating a difference in the number of operations for different search areas in the reference image in the template matching operation between the reference technology and the present exemplary embodiment. According to the reference technology and the present exemplary embodiment, the number of operations increases in proportion to the increase in search area.

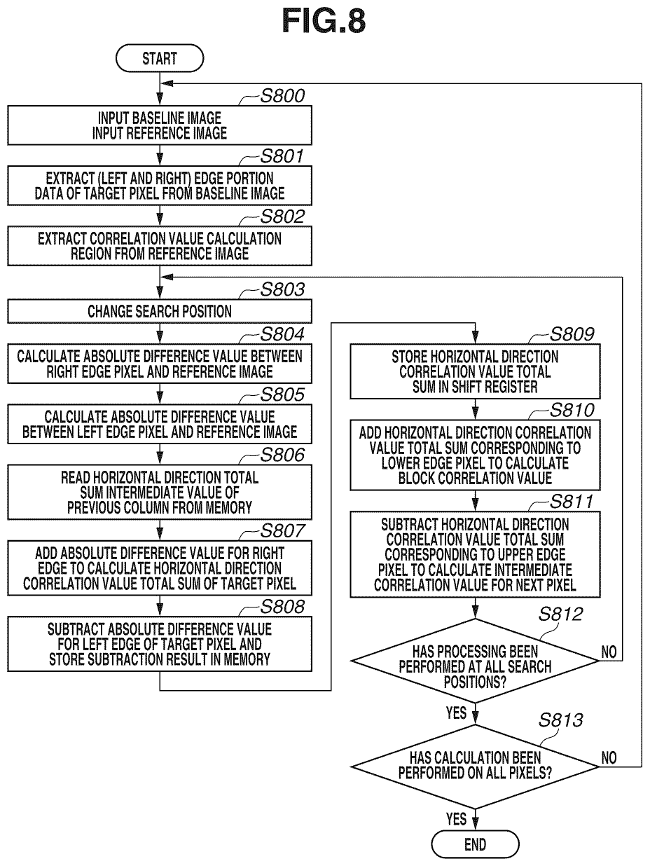

An operation flow according to the present exemplary embodiment will be described below. FIG. 8 is a flowchart illustrating a processing method of the image processing apparatus 110 illustrated in FIG. 1.

In step S800, the image input unit 100 inputs a baseline image and a reference image, and the processing proceeds to step S801. In this process, the baseline image and the reference image are input and scanned in a direction perpendicular to the search direction. According to the present exemplary embodiment, since the search direction is the horizontal direction, the baseline image and the reference image are input and scanned in the vertical direction.

In step S801, the edge portion data extraction unit 102 extracts left edge data and right edge data (edge portion data) of a matching region centered at a target pixel from the baseline image, and the processing proceeds to step S802.

In step S802, the correlation value calculation target region data extraction unit 103 extracts, from the reference image, a correlation value calculation region (matching region) for which correlations with the edge portion data extracted in step S802 are calculated, and the processing proceeds to step S803.

In step S803, the correlation value calculation units 104 change the search position, and the processing proceeds to step S804.

In step S804, the right edge absolute difference value generation unit 200 calculates an absolute difference value between the right edge data extracted in step S801 and the corresponding pixel in the correlation value calculation region extracted in step S802, and the processing proceeds to step S805.

In step S805, the left edge absolute difference value generation unit 201 calculates an absolute difference value between the left edge data extracted in step S801 and the corresponding pixel in the correlation value calculation region extracted in step S802, and the processing proceeds to step S806.

In step S806, the horizontal total sum addition unit 202 reads the intermediate value of the total sum in the horizontal direction of the previous column from the horizontal direction total sum holding memory 404, and the processing proceeds to step S807.

In step S807, the horizontal total sum addition unit 202 adds the absolute difference value calculated in step S804 to the intermediate value of the total sum in the horizontal direction that is read in step S806, to calculate a total sum of correlation values in the horizontal direction of the target pixel, and the processing proceeds to step S808.

In step S808, the horizontal total sum subtraction unit 203 subtracts the absolute difference value calculated in step S805 from the total sum of correlation values in the horizontal direction that is calculated in step S807 and stores the subtraction result in the horizontal direction total sum holding memory 404 as an intermediate value of the total sum in the horizontal direction that is to be referred to in the next column. Then, the processing proceeds to step S809.

In step S809, the horizontal total sum addition unit 202 stores the total sum sad_x of correlation values in the horizontal direction that is calculated in step S807 in the shift register 503 (vertical correlation value total sum holding unit 205), and the processing proceeds to step S810.

In step S810, the vertical total sum addition unit 207 adds the total sum sad_x[4] of correlation values in the horizontal direction that corresponds to the lower edge of the block centered at the target pixel to the intermediate total sum value sad_y_tmp to calculate a correlation value sad_y for the entire block, and the processing proceeds to step S811.

In step S811, the vertical total sum subtraction unit 206 subtracts the total sum sad_x[0] of correlation values in the horizontal direction that corresponds to the upper edge of the block centered at the target pixel from the correlation value sad_y for the entire block that is calculated in step S810, to calculate an intermediate correlation value sad_y_tmp for the entire block that is to be referred to in the next pixel, and the processing proceeds to step S812.

In step S812, the correlation value calculation units 104 determine whether the correlation value calculation processing has been performed at all search positions. In a case where the correlation value calculation units 104 determine that the correlation value calculation process has not been performed at all search positions (NO in step S812), the processing returns to step S803, and the search position is changed. Then, steps S804 to S811 are repeated. In a case where the correlation value calculation units 104 determine that the correlation value calculation process has been performed at all search positions (YES in step S812), the processing proceeds to step S813.

In step S813, the correlation value calculation units 104 determine whether the correlation value calculation has been performed on all pixels treated as target pixels. In a case where the correlation value calculation units 104 determine that the correlation value calculation has not been performed on all pixels treated as target pixels (NO in step S813), the processing returns to step S800, and the scanning shifts to the next pixel to repeat the correlation value calculation process with the pixel being the target pixel. In a case where the correlation value calculation units 104 determine that the correlation value calculation has been performed on all pixels treated as target pixels (YES in step S813), the process in the flowchart in FIG. 8 is ended.

As described above, the images are input and scanned in the direction perpendicular to the search direction, and the correlation value calculation is performed in parallel for all search positions in the search area. In this processing, the total sum of the correlation values from the previous column in the horizontal direction and the total sum of the correlation values from the previous row in the vertical direction are reused to reduce the number of operations.

Furthermore, the memory size for holding the total sums of correlation values in the horizontal direction can be limited to the vertical size of the input image, which reduces the circuit size. In a case where, for example, the inputting and scanning are performed in the horizontal direction, while total sums of correlation values in the horizontal direction can be calculated using the shift register, the memories for holding the total sums of correlation values in the horizontal direction need to be sufficient for (vertical block size−1)×search area in order to perform the calculation in the vertical direction.

In a case where the SSD is employed as the correlation operation method, the correlation operation results are sums of squares of differences, and the number of bits of total sums of correlation values tends to increase, so that it is useful to suppress consumption of the memory for holding the total sums of correlation values in the horizontal direction by inputting and scanning the images in the vertical direction with respect to the search in the horizontal direction.

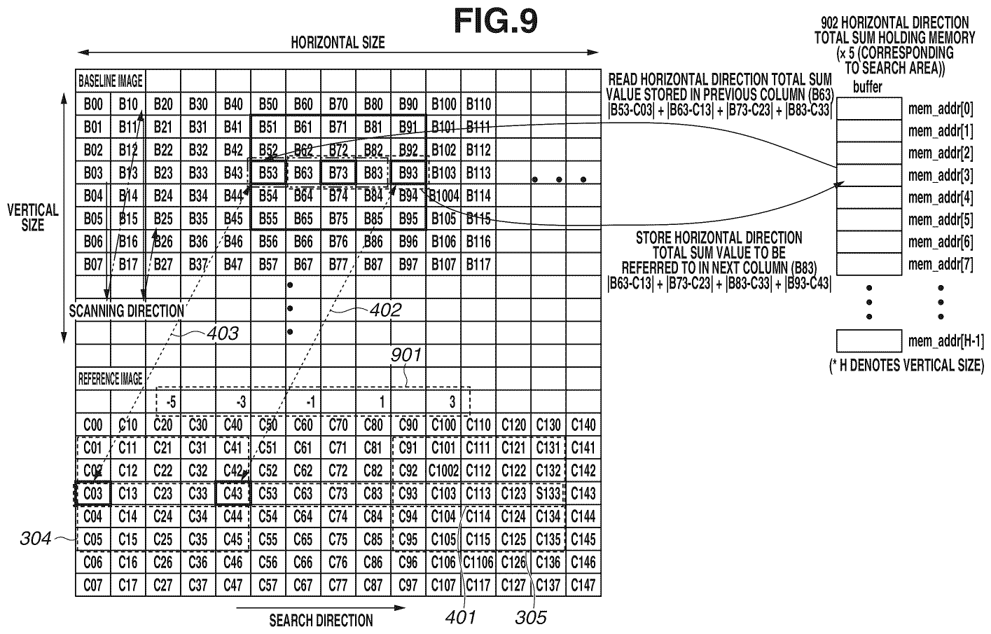

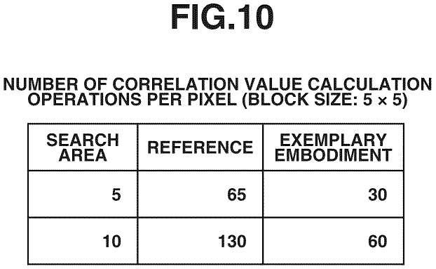

A second exemplary embodiment will be described below with reference to the drawings. While an example of calculating parallax in the case where the search area is 10 and the block size is 5×5 according to the first exemplary embodiment is described above, there may be cases where it is desirable to prioritize reducing the number of operations and suppressing memory consumption. A method in which the search area is downsampled to reduce the number of operations and suppress memory consumption will be described below with reference to FIGS. 9 and 10.

FIG. 9 is a diagram illustrating a process of calculating total sums of correlation values in the horizontal direction in the template matching operation of the correlation value calculation units 104 according to the present exemplary embodiment. While an example in the case where the search area is 10 according to the first exemplary embodiment is described above, the search area of ten pixels is downsampled to a search area 901 of five pixels {−5, −3, −1, 1, 3} according to the present exemplary embodiment as illustrated in in FIG. 9. In the case of performing the process of calculating total sums of correlation values in the horizontal direction, a horizontal direction total sum holding memory 902 sufficient for the search area is necessary. Since the search area is reduced to half, the required amount of the horizontal direction total sum holding memory 902 is also reduced by half, so that memory usage for five pixels is sufficient.

FIG. 10 is a diagram illustrating a comparison of the number of correlation value calculation operations per pixel in the template matching operation between the reference technology and the present exemplary embodiment. In FIG. 6, the number of operations per pixel according to the reference technology and the number of operations per pixel according to the first exemplary embodiment in a case where the search area is 10 are illustrated. In FIG. 10, the number of operations per pixel according to the reference technology and the number of operations per pixel according to the first exemplary embodiment in a case where the search area is 5 are compared, and since the number of operations is proportional to the search area, the number of operations according to the present exemplary embodiment is reduced to half of the number of operations according to the first exemplary embodiment in a case where the search area is 10.

As described above, the search area is reduced by reducing parallax resolution by half, whereby the required amount of the horizontal direction total sum holding memory 902 in the process of calculating total sums of correlation values in the horizontal direction in the template matching operation is reduced.

While an example in which the search area is reduced by half from ten pixels to five pixels according to the present exemplary embodiment is described above, this is not a limiting search area. Other configurations and operation flows do not differ from those according to the first exemplary embodiment, so that redundant descriptions thereof are omitted.

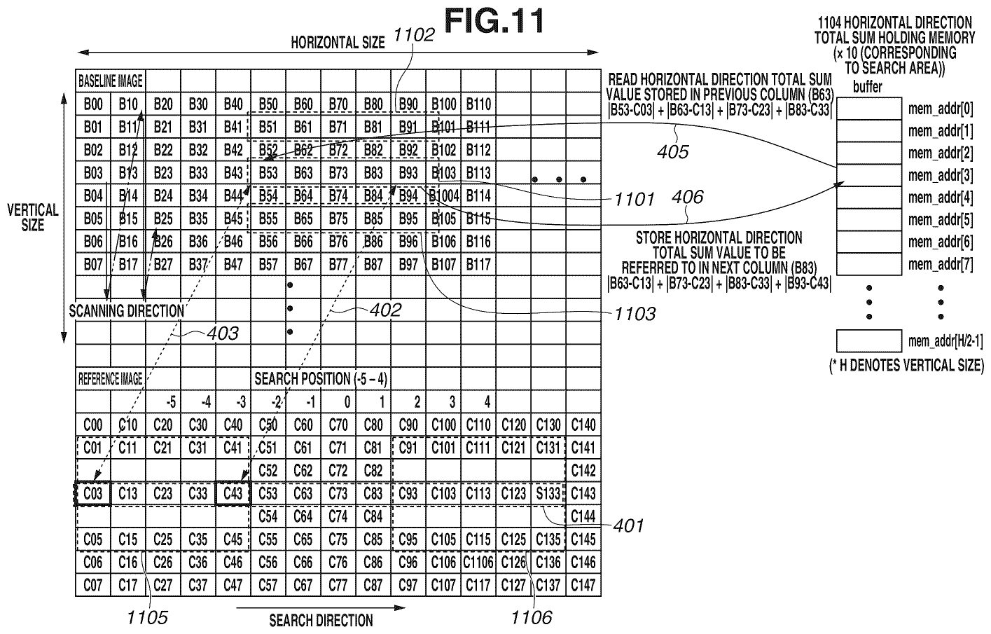

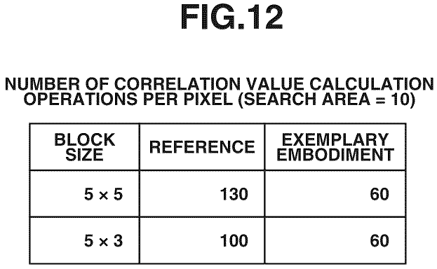

A third exemplary embodiment will be described below with reference to the drawings. A method in which the block size is decreased by downsampling parallax output to suppress memory consumption will be described below with reference to FIGS. 11 and 12.

FIG. 11 is a diagram illustrating a process of calculating total sums of correlation values in the horizontal direction in the template matching operation of the correlation value calculation units 104 according to the present exemplary embodiment. While an example in which the block size is 5×5 and the parallax calculation is performed according to the first exemplary embodiment is described above, the block size is downsampled to 5×3 by downsampling the pixels for which the parallax calculation is to be performed in the vertical direction according to the present exemplary embodiment. A case where the pixel B73 is a target pixel and the search area is-5 will be described below.

In this case, operation targets are total sums of correlation values in the horizontal direction of a portion 1101, an upper edge portion 1102, and a lower edge portion 1103 centered at the pixel B73 in FIG. 11. The correlation value calculation units 104 calculate a correlation value using the total sum of the following 5×3 absolute difference values as follows:
   |B51−C01|+|B61−C11|+|B71−C21|+|B81−C31|+|B91−C41|+|B53−C03|+|B63−C13|+|B73−C23|+|B83−C33|+|B93−C43|+|B55−C05|+|B65−C15|+|B75−C25|+|B85−C35|+|B95−C45|.

In the case of performing the parallax calculation and the process of calculating total sums of correlation values in the horizontal direction, a horizontal direction total sum holding memory 1104 sufficient for the vertical size of input images is used. However, since the parallax calculation is downsampled and the block size is downsampled to 5×3, the calculation of a total sum of correlation values in the horizontal direction is performed every two lines, so that the amount of the horizontal direction total sum holding memory 1104 to be used is reduced by half. In FIG. 11, a region 1105 is a 5×3 matching region of the search position-5 corresponding to the target pixel B73, and a region 1106 is a 5×3 matching region of the search position 4 corresponding to the target pixel B73.

FIG. 12 is a diagram illustrating a comparison of the number of correlation calculation operations per pixel in the template matching operation between the reference technology and the present exemplary embodiment. As described above with reference to FIG. 7A, the number of operations does not depend on the block size according to the first exemplary embodiment, so that even in a case where the block size is changed from 5×5 to 5×3 according to the present exemplary embodiment, the number of operations remains unchanged. According to the reference technology, the number of operations depends on the block size, so that in a case where the block size is decreased, the number of operations decreases.

As described above, the parallax calculation and the block size are downsampled, whereby the amount of the horizontal direction total sum holding memory 1104 to be used in the process of calculating total sums of correlation values in the horizontal direction in the template matching operation is reduced.

While an example in which the parallax calculation is downsampled in the vertical direction and the block size is downsampled to 5×3 according to the present exemplary embodiment is described above, this is not a limiting size. The image input may be divided spatially into upper and lower portions to enable memory reduction. Other configurations and operation flows do not differ from those according to the first and second exemplary embodiments, so that the redundant descriptions are omitted.

According to the first to third exemplary embodiments described above, the horizontal total sum addition unit 202 and the horizontal total sum subtraction unit 203 are examples of a horizontal total sum calculation unit. The vertical total sum subtraction unit 206 and the vertical total sum addition unit 207 are examples of a vertical total sum calculation unit.

The horizontal total sum calculation unit calculates a total sum of a correlation value between a first matching region of a baseline image and a first matching region of a reference image in a horizontal direction for each row and stores a value for each row in the horizontal correlation value total sum holding unit 204 based on the total sum of the correlation value in the horizontal direction for each row.

The first matching region of the baseline image is, for example, the 5×5 matching region 302 centered at the target pixel B73. The first matching region of the reference image is, for example, the 5×5 matching region 304 centered at the pixel C23.

The vertical total sum calculation unit calculates a total sum of a correlation value between the first matching region of the baseline image and the first matching region of the reference image in a vertical direction based on the total sum of the correlation value between the first matching region of the baseline image and the first matching region of the reference image in the horizontal direction for each row.

Then, the horizontal total sum calculation unit calculates a total sum of a correlation value between a second matching region of the baseline image and a second matching region of the reference image in the horizontal direction for each row using the value for each row that is stored in the horizontal correlation value total sum holding unit 204.

The second matching region of the baseline image is, for example, a 5×5 matching region centered at the target pixel B83. The second matching region of the reference image is, for example, a 5×5 matching region centered at the pixel C33. The first matching region and the second matching region of the baseline image partially overlap with each other. The first matching region and the second matching region of the reference image partially overlap with each other. Specifically, the second matching region of the baseline image is a region shifted by one pixel to the right from the first matching region of the baseline image, and the second matching region of the reference image is a region shifted by one pixel to the right from the first matching region of the reference image.

The vertical total sum calculation unit calculates a total sum of a correlation value between the second matching region of the baseline image and the second matching region of the reference image in the vertical direction based on the total sum of the correlation value between the second matching region of the baseline image and the second matching region of the reference image in the horizontal direction for each row.

The parallax information acquisition unit 105 acquires parallax information based on the total sum of the correlation value that is calculated by the vertical total sum calculation unit.

The horizontal total sum subtraction unit 203 stores, in the horizontal correlation value total sum holding unit 204, a value for each row that is obtained by subtracting a correlation value between a left edge of the row of the first matching region of the baseline image and a left edge of the row of the first matching region of the reference image from the total sum of the correlation value between the first matching region of the baseline image and the first matching region of the reference image in the horizontal direction for the row.

The horizontal total sum addition unit 202 calculates the total sum of the correlation value between the second matching region of the baseline image and the second matching region of the reference image in the vertical direction by adding the value for each row that is stored in the horizontal correlation value total sum holding unit 204 to a correlation value between a right edge of the row of the second matching region of the baseline image and a right edge of the row of the second matching region of the reference image.

The vertical total sum subtraction unit 206 calculates an intermediate value sad_y_tmp by subtracting a total sum sad_x[0] of a correlation value between an upper edge row of the first matching region of the baseline image and an upper edge row of the first matching region of the reference image from the total sum sad_y of the correlation value between the first matching region of the baseline image and the first matching region of the reference image in the vertical direction.

The vertical total sum addition unit 207 calculates a total sum of a correlation value between a third matching region of the baseline image and a third matching region of the reference image in the vertical direction by adding the intermediate value sad_y_tmp to a total sum sad_x[4] of a correlation value between a lower edge row of the third matching region of the baseline image and a lower edge row of the third matching region of the reference image.

The third matching region of the baseline image is, for example, a 5×5 matching region centered at the target pixel B74. The third matching region of the reference image is, for example, a 5×5 matching region centered at the pixel C24. The first matching region and the third matching region of the baseline image partially overlap with each other. The first matching region and the third matching region of the reference image partially overlap with each other. Specifically, the third matching region of the baseline image is a region shifted by one pixel downward from the first matching region of the baseline image, and the third matching region of the reference image is a region shifted by one pixel downward from the first matching region of the reference image.

The total sum sad_x[0] of the correlation value between the upper edge rows and the total sum sad_x[4] of the correlation value between the lower edge rows are stored in the shift register 503.

The correlation value is, for example, an absolute value of a difference between a pixel value of the baseline image and a pixel value of the reference image. The correlation value may be a sum of squares of a difference between a pixel value of the baseline image and a pixel value of the reference image.

According to the first exemplary embodiment, the horizontal total sum calculation unit and the vertical total sum calculation unit calculate a total sum of a correlation value by shifting a matching region of the reference image in the horizontal direction (search direction) with respect to the first matching region of the baseline image.

According to the second exemplary embodiment, the horizontal total sum calculation unit and the vertical total sum calculation unit calculate a total sum of a correlation value by downsampling a matching region of the reference image and shifting the matching region in the horizontal direction with respect to the first matching region of the baseline image.

According to the present exemplary embodiment, the horizontal total sum calculation unit calculates a total sum of a correlation value between the first matching region of the baseline image and the first matching region of the reference image in the horizontal direction for each downsampled row. The horizontal total sum calculation unit calculates a total sum of a correlation value between the second matching region of the baseline image and the second matching region of the reference image in the horizontal direction for each downsampled row.

The template matching operation of the correlation value calculation units 104 according to the first to third exemplary embodiments has been described above. Since the parallax calculation accuracy and the circuit size (memory usage) are in a trade-off relationship, a system in which the memory reduction effects described above are set as modes and switched for different use cases may be configured.

For example, in a case where the circuit size of a target field-programmable gate array (target FPGA) device is sufficient, the parallax calculation is executed without lowering the accuracy as in the first exemplary embodiment. In a case where the circuit size of the field-programmable gate array (FPGA) device is insufficient and it is acceptable to lower the parallax calculation accuracy, the circuit size is reduced by downsampling the search area and lowering the disparity resolution as in the second exemplary embodiment. In a case where it is unacceptable to lower the disparity resolution, the memory usage is reduced by reducing the parallax output resolution as in the third exemplary embodiment.

The foregoing disclosure is useful for developing a system in which the parallax resolution, resolution, and block size are set as parameters and settings are switched based on the priority of combinations.

The correlation value calculation units 104 input and scan images in the direction perpendicular to the search area, execute the correlation calculation process in parallel for all search positions in the search area, and reuse the total sum of correlation values from the previous column in the horizontal direction and the total sum of correlation values from the previous row in the vertical direction, whereby the number of operations is reduced.

With the correlation value calculation units 104, the size of memory for holding total sums of correlation values in the horizontal direction can be limited to a size corresponding to the input image height, which reduces the circuit size.

With the correlation value calculation units 104, since the number of operations does not depend on the block size, the block size can be increased to produce noise reduction effects. The correlation value calculation units 104 are also useful for cases where a FPGA is implemented and the consumption of FPGA resources such as memory is controlled based on an implemented design and a target device.

With the correlation value calculation units 104, template matching is realized while an increase in operation costs is suppressed even in a case where a matching region is enlarged.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-192291, filed Nov. 10, 2023, which is hereby incorporated by reference herein in its entirety.

What is claimed is:

1. An apparatus comprising:
a first calculation unit configured to calculate a total sum of a correlation value between a first matching region of a baseline image and a first matching region of a reference image in a horizontal direction for each row and store, in a holding unit, a value for each row based on the total sum of the correlation value in the horizontal direction for each row; and
a second calculation unit configured to calculate a total sum of a correlation value between the first matching region of the baseline image and the first matching region of the reference image in a vertical direction, based on the total sum of the correlation value between the first matching region of the baseline image and the first matching region of the reference image in the horizontal direction for each row,
wherein the first calculation unit calculates a total sum of a correlation value between a second matching region of the baseline image and a second matching region of the reference image in the horizontal direction for each row using the value for each row that is stored in the holding unit,
wherein the second calculation unit calculates a total sum of a correlation value between the second matching region of the baseline image and the second matching region of the reference image in the vertical direction, based on the total sum of the correlation value between the second matching region of the baseline image and the second matching region of the reference image in the horizontal direction for each row,
wherein the first matching region and the second matching region of the baseline image partially overlap with each other, and
wherein the first matching region and the second matching region of the reference image partially overlap with each other.

2. The apparatus according to claim 1, further comprising an acquisition unit configured to acquire parallax information based on the total sum of the correlation value that is calculated by the second calculation unit.

3. The apparatus according to claim 1,
wherein the first calculation unit stores, in the holding unit, a value for each row that is obtained by subtracting a correlation value between a left edge of the row of the first matching region of the baseline image and a left edge of the row of the first matching region of the reference image from the total sum of the correlation value between the first matching region of the baseline image and the first matching region of the reference image in the horizontal direction for the row, and
wherein the first calculation unit calculates the total sum of the correlation value between the second matching region of the baseline image and the second matching region of the reference image in the vertical direction by adding the value for each row that is stored in the holding unit to a correlation value between a right edge of the row of the second matching region of the baseline image and a right edge of the row of the second matching region of the reference image.

4. The apparatus according to claim 1,
wherein the second calculation unit calculates an intermediate value by subtracting a total sum of a correlation value between an upper edge row of the first matching region of the baseline image and an upper edge row of the first matching region of the reference image from the total sum of the correlation value between the first matching region of the baseline image and the first matching region of the reference image in the vertical direction,
wherein the second calculation unit calculates a total sum of a correlation value between a third matching region of the baseline image and a third matching region of the reference image in the vertical direction by adding the intermediate value to a total sum of a correlation value between a lower edge row of the third matching region of the baseline image and a lower edge row of the third matching region of the reference image,
wherein the first matching region and the third matching region of the baseline image partially overlap with each other, and
wherein the first matching region and the third matching region of the reference image partially overlap with each other.

5. The apparatus according to claim 4, wherein the total sum of the correlation value between the upper edge row of the first matching region of the baseline image and the upper edge row of the first matching region of the reference image and the total sum of the correlation value between the lower edge row of the third matching region of the baseline image and the lower edge row of the third matching region of the reference image are stored in a shift register.

6. The apparatus according to claim 1, wherein the correlation value is an absolute value of a difference between a pixel value of the baseline image and a pixel value of the reference image.

7. The apparatus according to claim 1, wherein the correlation value is a sum of squares of a difference between a pixel value of the baseline image and a pixel value of the reference image.

8. The apparatus according to claim 3, wherein the second matching region of the baseline image is a region shifted by one pixel to the right from the first matching region of the baseline image, and the second matching region of the reference image is a region shifted by one pixel to the right from the first matching region of the reference image.

9. The apparatus according to claim 4, wherein the third matching region of the baseline image is a region shifted by one pixel downward from the first matching region of the baseline image, and the third matching region of the reference image is a region shifted by one pixel downward from the first matching region of the reference image.

10. The apparatus according to claim 1, wherein the first calculation unit and the second calculation unit calculate a total sum of a correlation value by shifting a matching region of the reference image in the horizontal direction with respect to the first matching region of the baseline image.

11. The apparatus according to claim 1, wherein the first calculation unit and the second calculation unit calculate a total sum of a correlation value by downsampling a matching region of the reference image and shifting the matching region in the horizontal direction with respect to the first matching region of the baseline image.

12. The apparatus according to claim 1, wherein the first calculation unit calculates a total sum of a correlation value between the first matching region of the baseline image and the first matching region of the reference image in the horizontal direction for each downsampled row and calculates a total sum of a correlation value between the second matching region of the baseline image and the second matching region of the reference image in the horizontal direction for each downsampled row.

13. A method of an apparatus comprising:
calculating, as first calculation, a total sum of a correlation value between a first matching region of a baseline image and a first matching region of a reference image in a horizontal direction for each row and store, in a holding unit, a value for each row based on the total sum of the correlation value in the horizontal direction for each row;
calculating, as second calculation, a total sum of a correlation value between the first matching region of the baseline image and the first matching region of the reference image in a vertical direction, based on the total sum of the correlation value between the first matching region of the baseline image and the first matching region of the reference image in the horizontal direction for each row;
calculating, as third calculation, a total sum of a correlation value between a second matching region of the baseline image and a second matching region of the reference image in the horizontal direction for each row using the value for each row that is stored in the holding unit; and
calculating, as fourth calculation, a total sum of a correlation value between the second matching region of the baseline image and the second matching region of the reference image in the vertical direction, based on the total sum of the correlation value between the second matching region of the baseline image and the second matching region of the reference image in the horizontal direction for each row,
wherein the first matching region and the second matching region of the baseline image partially overlap with each other, and
wherein the first matching region and the second matching region of the reference image partially overlap with each other.

14. The method according to claim 13, further comprising acquiring parallax information based on the total sum of the correlation value that is calculated by the second calculation.

15. The method according to claim 13,
wherein the first calculation stores, in the holding unit, a value for each row that is obtained by subtracting a correlation value between a left edge of the row of the first matching region of the baseline image and a left edge of the row of the first matching region of the reference image from the total sum of the correlation value between the first matching region of the baseline image and the first matching region of the reference image in the horizontal direction for the row, and
wherein the first calculation calculates the total sum of the correlation value between the second matching region of the baseline image and the second matching region of the reference image in the vertical direction by adding the value for each row that is stored in the holding unit to a correlation value between a right edge of the row of the second matching region of the baseline image and a right edge of the row of the second matching region of the reference image.

16. The method according to claim 13,
wherein the second calculation calculates an intermediate value by subtracting a total sum of a correlation value between an upper edge row of the first matching region of the baseline image and an upper edge row of the first matching region of the reference image from the total sum of the correlation value between the first matching region of the baseline image and the first matching region of the reference image in the vertical direction,
wherein the second calculation calculates a total sum of a correlation value between a third matching region of the baseline image and a third matching region of the reference image in the vertical direction by adding the intermediate value to a total sum of a correlation value between a lower edge row of the third matching region of the baseline image and a lower edge row of the third matching region of the reference image,
wherein the first matching region and the third matching region of the baseline image partially overlap with each other, and
wherein the first matching region and the third matching region of the reference image partially overlap with each other.

17. A non-transitory storage medium storing a program causing an apparatus to execute a method, the method comprising:
calculating, as first calculation, a total sum of a correlation value between a first matching region of a baseline image and a first matching region of a reference image in a horizontal direction for each row and store, in a holding unit, a value for each row based on the total sum of the correlation value in the horizontal direction for each row;
calculating, as second calculation, a total sum of a correlation value between the first matching region of the baseline image and the first matching region of the reference image in a vertical direction, based on the total sum of the correlation value between the first matching region of the baseline image and the first matching region of the reference image in the horizontal direction for each row;
calculating, as third calculation, a total sum of a correlation value between a second matching region of the baseline image and a second matching region of the reference image in the horizontal direction for each row using the value for each row that is stored in the holding unit; and
calculating, as fourth calculation, a total sum of a correlation value between the second matching region of the baseline image and the second matching region of the reference image in the vertical direction, based on the total sum of the correlation value between the second matching region of the baseline image and the second matching region of the reference image in the horizontal direction for each row,
wherein the first matching region and the second matching region of the baseline image partially overlap with each other, and
wherein the first matching region and the second matching region of the reference image partially overlap with each other.

18. The non-transitory storage medium according to claim 17, further comprising acquiring parallax information based on the total sum of the correlation value that is calculated by the second calculation.

19. The non-transitory storage medium according to claim 17,
wherein the first calculation stores, in the holding unit, a value for each row that is obtained by subtracting a correlation value between a left edge of the row of the first matching region of the baseline image and a left edge of the row of the first matching region of the reference image from the total sum of the correlation value between the first matching region of the baseline image and the first matching region of the reference image in the horizontal direction for the row, and
wherein the first calculation calculates the total sum of the correlation value between the second matching region of the baseline image and the second matching region of the reference image in the vertical direction by adding the value for each row that is stored in the holding unit to a correlation value between a right edge of the row of the second matching region of the baseline image and a right edge of the row of the second matching region of the reference image.

20. The non-transitory storage medium according to claim 17,
wherein the second calculation calculates an intermediate value by subtracting a total sum of a correlation value between an upper edge row of the first matching region of the baseline image and an upper edge row of the first matching region of the reference image from the total sum of the correlation value between the first matching region of the baseline image and the first matching region of the reference image in the vertical direction,
wherein the second calculation calculates a total sum of a correlation value between a third matching region of the baseline image and a third matching region of the reference image in the vertical direction by adding the intermediate value to a total sum of a correlation value between a lower edge row of the third matching region of the baseline image and a lower edge row of the third matching region of the reference image,
wherein the first matching region and the third matching region of the baseline image partially overlap with each other, and
wherein the first matching region and the third matching region of the reference image partially overlap with each other.
